(19) United States
(12) Patent Application Publication
(10) Pub. No.: US 2003/0140149 A1
(43) Pub. Date: Jul. 24, 2003

(54) Communication protocol for use in controlling communications in a monitoring service system

(76) Inventors: Richard Marejka, Nobleton (CA); David Haynes, Streetsville (CA)

Correspondence Address: HOGAN & HARTSON LLP, ONE TABOR CENTER, SUITE 1500, 1200 SEVENTEEN ST., DENVER, CO, 80202, US

(21) Appl. No.: 10/178,117

(22) Filed: Jun. 24, 2002

Related U.S. Application Data
(60) Provisional application No. 60/348,599, filed on Jan. 14, 2002.
(60) Provisional application No. 60/377,115, filed on Apr. 30, 2002.

(51) Int. Cl. G06F 15/16

(52) U.S. Cl. 709/229

(57) ABSTRACT

A communication protocol for relay-to-relay communications. Message format includes a fixed length and format header including protocol, command, and length fields and a variable length data section defined by commands in the header selected from a limited command set and by the length field of the header. The protocol includes starting transmission by transmitting a relay identification command to the receiving relay which verifies status of the sending relay and transmits a relay identification acknowledgment. The sending relay transmits the highest priority message in its queues by sending a start of message command identifying the message to be sent and its priority. The receiving relay responds with an acknowledgment and the sending relay sends message segments. The receiving relay does not acknowledge the message segments. The sending relay indicates an empty message file by transmitting an end of message command and the receiving relay replies with an acknowledgment.

### CROSS-REFERENCE TO RELATED APPLICATIONS

This application claims the benefit of U.S. Provisional Application No. 60/348,599, filed Jan. 14, 2002, and U.S. Provisional Application No. 60/377,115, filed Apr. 30, 2002, the disclosures of which are herein specifically incorporated in their entirety by this reference.

### BACKGROUND OF THE INVENTION

1. Field of the Invention

The present invention relates, in general, to data communications in computer networks, and more particularly, to a communication protocol for use in controlling data transfer between relays or other computer and communication devices within a communication pipeline used to transfer data during monitoring, reporting, and asset tracking operations from monitored client or customer systems to a remote service provider server and/or system.

2. Relevant Background

The need for effective and cost efficient monitoring of computer systems, networks, and components, i.e., systems management, continues to grow at a rapid pace in all areas of commerce. There are many reasons system management solutions are adopted by companies including reducing customer and service downtime to improve customer service and staff and customer productivity, reducing computer and network costs, and reducing operating expenditures (including reducing support and maintenance staff needs). A recent computer industry study found that the average cost per hour of system downtime for companies was $90,000 with each company experiencing 9 or more hours of mission-critical system downtime per year. For these and other reasons, the market for system monitoring and management tools has increased dramatically and with this increased demand has come pressure for more effective and user-friendly tools and features.

There are a number of problems and limitations associated with existing system monitoring and management tools. Generally, these tools require that software and agents be resident on the monitored systems and network devices to collect configuration and operating data and to control communications among the monitored devices, control and monitoring consoles, and a central, remote service provider. While providing useful information to a client operator (e.g., self-monitoring by client personnel), these monitoring tools often require a relatively large amount of system memory and operating time (e.g., 1 to 2 percent of system or device processing time).

Additionally, the volume of data and messages sent between monitored systems and the service provider server can vary significantly over time leading to congestion within the network and the delay or loss of important monitoring and control information. The number and size of the messages transferred between monitored systems and the service provider can be quite large to display collected data on the monitoring console or client node and to provide alerts via visual displays, emails, and page messages upon the detection of an operating problem. Data sent from a monitored system to the service provider needs to be transferred in a reliable, secure, and efficient manner. A significant amount of effort has been spent to provide useful communication controls or protocols for managing the communication over public networks, such as the TCP/IP suite for the Internet, and these networks are typically used to link the service provider system and the customer environment or network. However, communication protocols for managing data transfers within a monitored customer environment have not been successfully developed or implemented in a computer system to meet the communication needs of both the customer and the service provider.

In this regard, a communication protocol is a set of rules that governs the interaction of concurrent processes in distributed and linked systems. Designing a logically consistent protocol that can be proven correct is a challenging and frustrating task as the protocol needs to include all rules, formats, and procedures agreed upon between two communicating devices used for initiation and termination of data exchanges, synchronization of senders and receivers, detection and correction of transmission errors, and formatting and encoding of data. Most protocols can be thought of as providing a virtual, full-duplex communication channel between to similar protocol layers in linked devices. For example, the International Standards Organization (ISO) provides a seven layer protocol stack or hierarchy including, from lowest to highest layer: a physical layer, a data link layer, a network layer, a transport layer, a session layer, a presentation layer, and an application layer. Each layer in the stack defines a distinct service and implements a different protocol with higher layers building on or using the services provided by the lower layers. For example, the physical layer implements a byte-stream protocol that includes all functions or services applying to the actual transmission of bits over a physical connection and defines whether the connection is copper wire, a coaxial cable, optical fiber, and the like. The data link layer then uses the services of the physical layer and byte-stream protocol by implementing a link-level protocol to create a reliable link adding services such as error handling and flow control. Similarly, higher layers such as the network layer (which may implement the well-known IP protocol) and the transport layer (which may implement the well-known TCP protocol) build on these two lower layers with the remaining higher layers building again on these layers.

A protocol designer may provide a new protocol for any of these layers by building on existing or known protocols, such as byte-stream protocols and the TCP/IP suite of network and transport protocols. In the customer environment of a monitoring service, there remains a need for a protocol such as a session layer protocol that builds on a reliable byte-stream protocol and, typically, on known network and transport protocols to coordinate and enhance communications between monitored devices, pipeline or network relays, and Internet interfaces or relays. Preferably, such a protocol would define communications within a monitored customer environment in a space efficient manner that transfers monitoring service data, commands, and messages with less space or byte overhead. The protocol preferably would provide time efficient control with low time overhead with, in some cases, priority-based transfer of messages based on the value to the monitoring system of the message content and with preemption or interruption of lower priority messages. Additionally, any such protocol should be verifiably correct.

### SUMMARY OF THE INVENTION

To address the above and other needs, the present invention provides a communication or pipeline protocol for use in the customer portion or environment of a monitoring service system. Briefly, the system that implements the protocol uses a cascaded pipeline architecture including linked monitored relays, forwarding relays, and Internet relays each including relay-to-relay and other mechanisms for controlling data transfer according to the protocol. The monitored relays are end node systems connected to the pipeline. The forwarding relays are linked to the pipeline and positioned upstream of the monitored relays and configured to support 1 to 500 or more end node systems or monitored relays. The Internet relays are positioned upstream of the forwarding relays and are the final point within the customer environment or network. The Internet relays function to send messages and data to the service provider system.

More particularly, each of the relays includes one or more relay-to-relay interfaces that implement a protocol for controlling relay-to-relay communications. The communication protocol is typically built on lower layer protocols such as the TCP/IP protocol suite that include a reliable byte-stream protocol. Messages transferred according to the protocol are formatted to include a fixed length (such as 16 bytes) header with a fixed format including a protocol field, a command field, and a length field. A variable length data section is provided with the content and format of the data being defined by the commands in the command field which are selected from a command set and the size of the data section being defined by a value in the length field of the header.

During operation of the system, the protocol calls for a sending relay to start transmission by transmitting a relay identification command message to the receiving relay which verifies the sending relay is registered and transmits a relay identification acknowledgment message. The sending relay then transmits the highest priority message in its queues by sending a start of message command message identifying the message to be sent and its size and priority. The receiving relay responds with an acknowledgment of the start of message command. The sending relay then begins sending message segments in messages having a message segment command. The receiving relay does not acknowledge the message segments, which significantly reduces the number of commands required under the protocol to transmit each message file. The sending relay indicates an empty message file with the transmittal of an end of message command in a message which the receiving relay replies to with an end of message acknowledgment that indicates either a positive status for proper receipt and storage of all message segments or a negative status indicating an error indicating resending the message segments is required.

Each start of message command message includes a priority for the message to be transmitted (for proper message storage and to support transfer by the receiving relay). Priority-based messaging is further provided by the protocol by requiring the sending relay to check for the presence of a higher priority message file in the relay queues after transmittal of each message segment message. When a higher priority message file is present, transmittal of the lower priority message is interrupted and a start of message command message is transmitted for the higher priority message file. The receiving relay verifies the priority in this message and responds with a start of message acknowledgment. In response, the sending relay transmits one or more message segment messages to send the higher priority message file followed by an end of message command to the receiving relay. The receiving relay responds by closing the received message file and transmitting an end of message acknowledgment to the sending relay (which again can be positive or negative). The sending relay responds by resuming sending message segments from the interrupted message file, without having to restart the transmission at the beginning of the message file.

### BRIEF DESCRIPTION OF THE DRAWINGS

FIG. 1 illustrates a self-monitoring service system according to the present invention generally showing the use of forwarding or fan-out relays to provide scalability to link a service provider system and its services to a large number of monitored systems or relays within customer systems in which the communication protocol of the invention is used to control relay-to-relay messaging;

FIG. 2 illustrates one embodiment of a service system showing in detail components provided within the service provider system, the forwarding relay, and the monitored system or relay including relay-to-relay interfaces and other mechanisms used to implement the pipeline communication protocol of the invention and prioritized data transfer within the customer system;

FIG. 3 is a block diagram of portions of an exemplary forwarding relay illustrating use of the communication protocol of the invention to perform data and command flow and message building with upstream and downstream message queues during operation of the service system of FIG. 1 or FIG. 2;

FIG. 4 is a flow chart showing processes performed by a forwarding relay, such as the relay shown in FIG. 3, during operation of the service system of FIG. 1 or 2;

FIG. 5 illustrates a representative message format according to the novel communication protocol of the invention illustrating a fixed length header with a protocol field, a command field, a length field, and a NUL field and a variable length data section; and

FIG. 6 is a flow chart illustrating message transmission processes at the sending device or relay according to the protocol of the invention.

### DETAILED DESCRIPTION OF THE PREFERRED EMBODIMENTS

The present invention is directed to a communication protocol and communication method for use in a customer environment during self-monitoring services that monitor operation history and status regarding the customer computer systems and networks. The protocol is a relay-to-relay or sender-to-receiver protocol that controls transmission of messages (including collected monitoring and asset data, internal commands, and alerts) in the customer network or pipeline in a verifiably correct manner that is both space efficient (i.e., transfers messages with minimal space or byte overhead) and time efficient. In a preferred embodiment, the messaging is priority-based with the protocol transferring higher priority (or higher value) messages before lower priority messages and providing for, in some cases, interrupts of lower priority messages with the lower priority message transmittal being resumed at the interruption point (not restarted). The protocol is built on reliable lower level protocols, such as reliable physical layer, data link layer, and network and transport layer protocols (that may or may not include the TCP/IP protocol suite). Briefly, the communication or pipeline protocol provides for messages having fixed length headers including protocol, command, and length fields and variable length data fields with a length and data format defined by the length and command fields of the header. In one embodiment, replies or acknowledgments are provided for each transmitted command except for a shutdown command and for message segment commands, which results in a large saving in required messaging or commands that need to be sent to provide effective and reliable error and flow control between relays.

In the following description, a service system is provided that implements the communication protocol that includes forwarding or fan-out relays within the customer system. The forwarding relays are configured to provide a cascaded pipeline that controls the transmission of data and/or messages between a monitored relay or system and a service provider system and allows the customer system to be readily scaled up and down in size to include hundreds or thousands of monitored systems and nodes. As will become clear from the following description, the forwarding relays and monitored relays (as well as the Internet or customer relays) include relay-to-relay interfaces and other mechanisms that implement the communication protocol and provide a store and forward mechanism that functions to provide reliable messaging based on a messaging protocol and in preferred embodiments, transmits received messages based on a priority scheme that facilitates effective and timely communication of messages and data based on assigned priorities (e.g., priorities assigned by transmitting devices such as the monitored systems or relays and the service provider system).

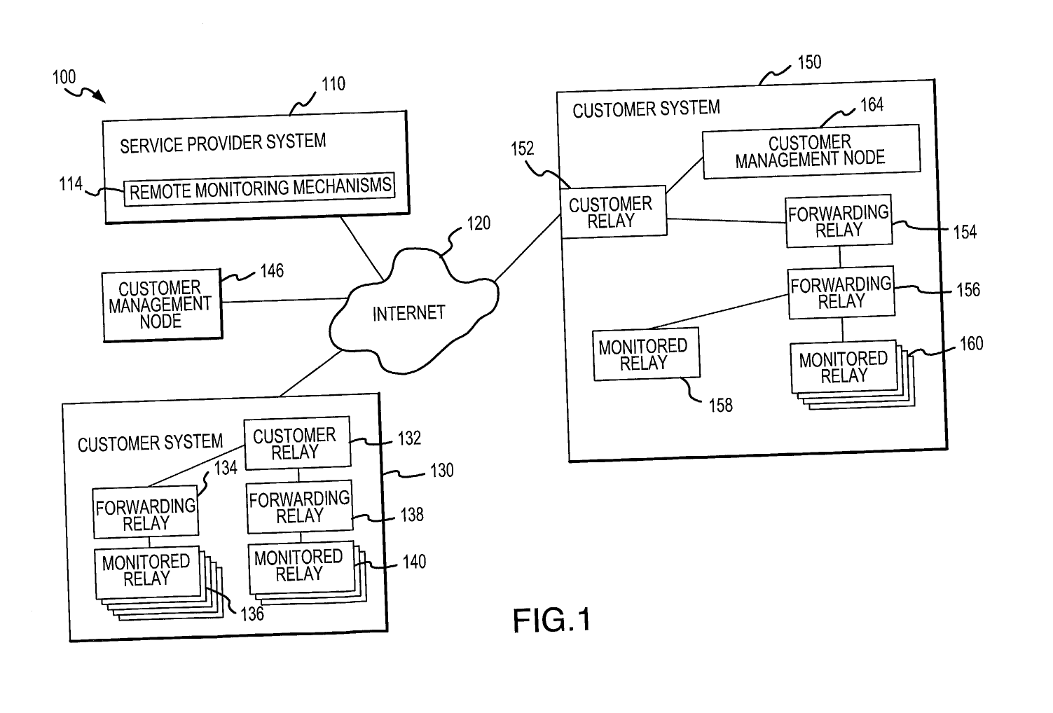

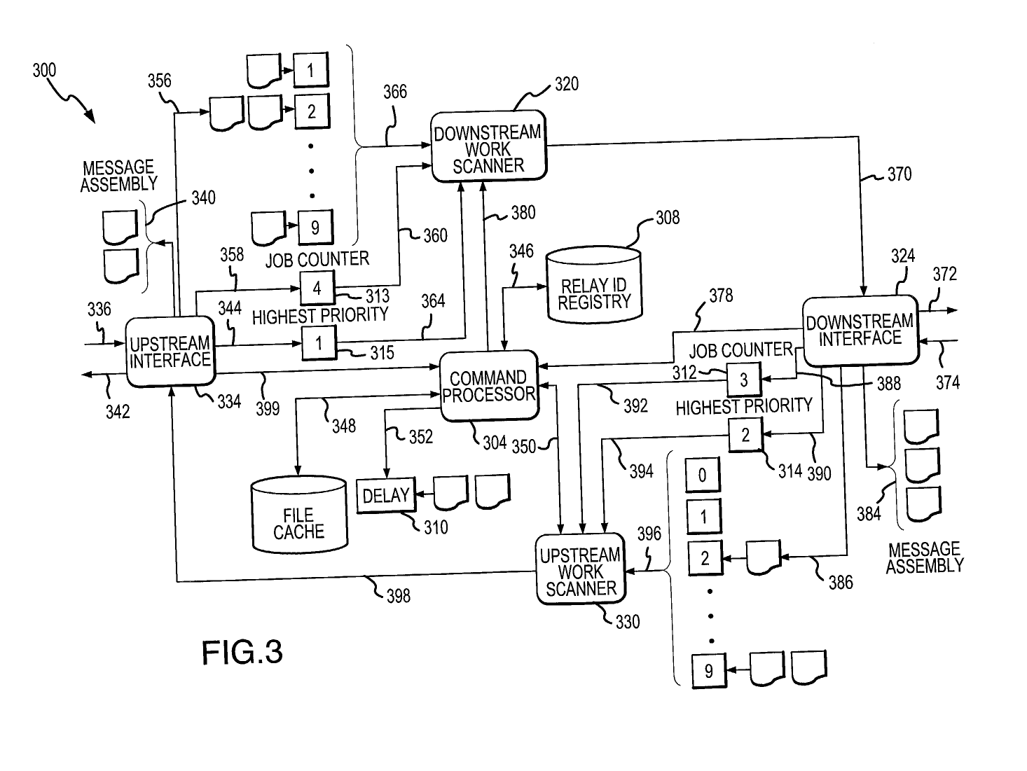

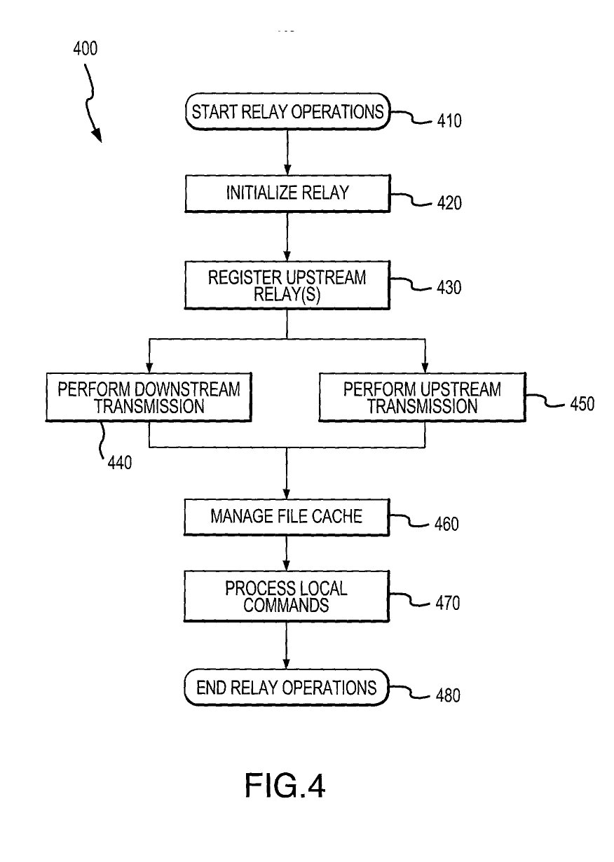

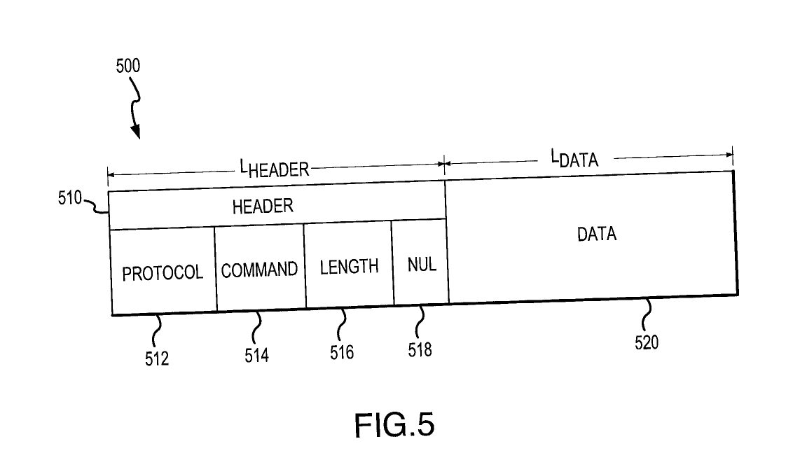

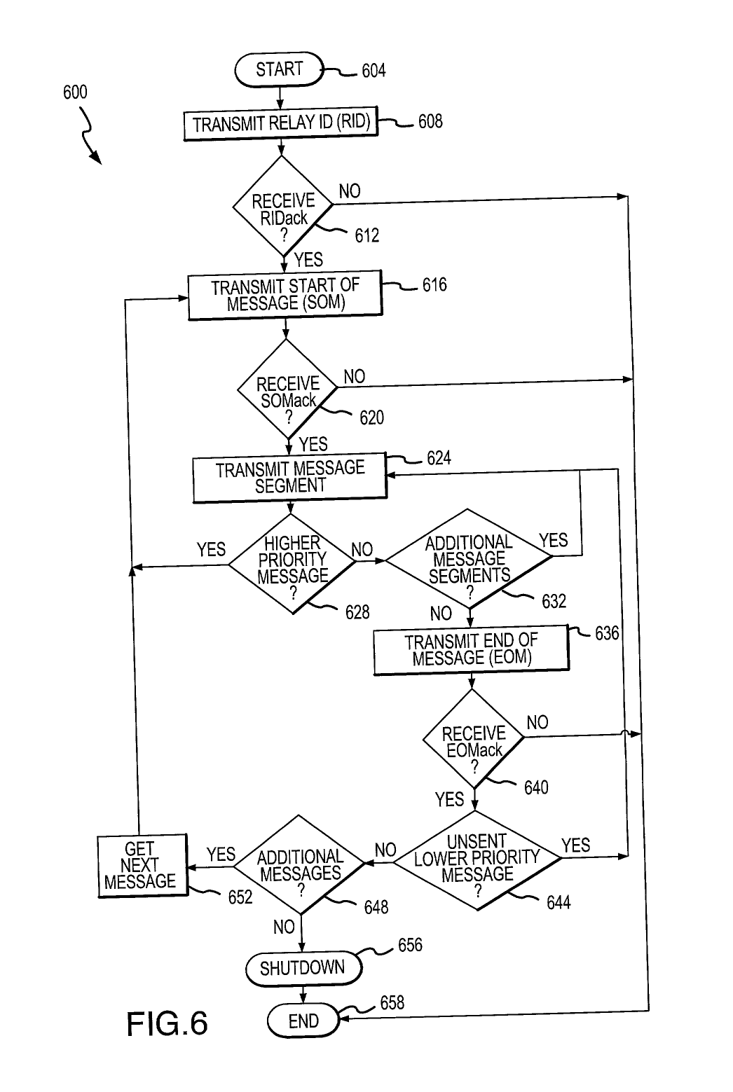

The following description begins with a discussion of a general description of a typical service system of the invention with reference to FIG. 1 and continues with a more specific description of the various components included within a service provider system, a forwarding relay, and a monitored system to provide the desired functions of the invention. Exemplary data flow within and operation of a forwarding relay to implement at the novel communication protocol of the invention when communicating with upstream and downstream relays are then described fully with reference to FIGS. 3 and 4. To more fully describe important features of the communication protocol, operation of a sender device or relay is then discussed with reference to FIGS. 5 and 6.

Referring to FIG. 1, a monitoring service system is shown that provides a scalable solution to delivering self-service solutions such as system monitoring, trend reporting, and asset tracking. The system 100 includes a service provider system 110 with remote monitoring mechanisms 114 that function to process collected data and provide event, alert, trending, status, and other relevant monitoring data in a useable form to monitoring personnel, such as via customer management nodes 146, 164. The service provider system 110 is linked to customer systems or sites 130, 150 by the Internet 120 (or any useful combination of wired or wireless digital data communication networks).

According to an important feature aspect of the invention communication protocols are utilized in the system 100 to provide channels or a pipeline with reliable messaging and communications with the protocols calling for specific message control and forwarding within the customer systems 130, 150 (such as between relays). The underlying or supporting protocols within lower layers of the protocol hierarchy may, however, be varied to practice the invention and may include numerous well-know byte-stream protocols and data-link, network, and transport layer protocols (such as but not limited to the TCP/IP protocol suite).

The service provider system 110 and customer systems 130, 150 (including the relays) may comprise any well-known computer and networking devices such as servers, data storage devices, routers, hubs, switches, and the like. The described features of the invention are not limited to a particular hardware configuration. The service system 100 is adapted to manage data transmissions within the customer systems 130, 150 and between the service provider system 110 and the customer systems 130, 150. In this regard, the system 100 includes a cascaded pipeline architecture that includes within the customer systems 130, 150 linked customer or Internet relays 132, 152, forwarding (or intermediate or fan-out) relays 134, 138, 154, 156, and monitored relays 136, 140, 158, 160. As will be discussed in detail, messaging within the pipeline in the customer systems 130, 150 is performed according to the protocol of the invention and the relays are configured to support protocol requirements.

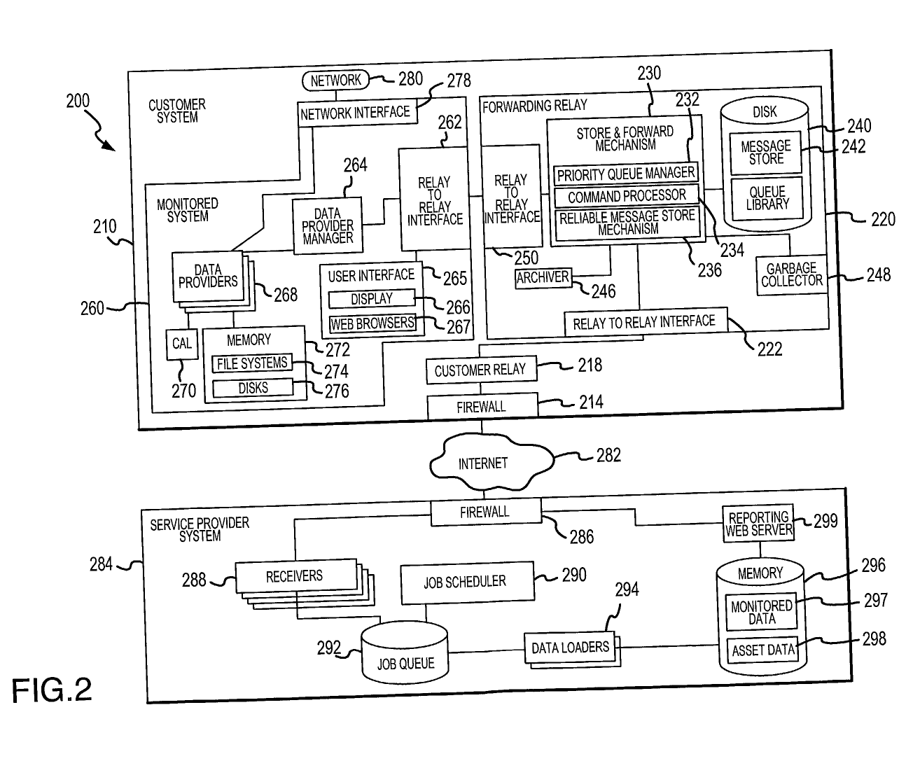

The monitored relays 136, 140, 158, 160 are end nodes or systems being monitored in the system 100 (e.g., at which configuration, operating, status, and other data is collected). The forwarding relays 134, 138, 154, 156 are linked to the monitored relays 136, 140, 158, 160 and configured to support (or fan-out) monitored systems to forwarding relay ratios of 500 to 1 or larger. The configuration and operation of the relays are a key part of the present invention and are described in detail with reference to FIGS. 2-6. In one embodiment, the pipeline is adapted to control the transmission of data or messages within the system and the relays act to store and forward received messages (from upstream and downstream portions of the pipeline) based on priorities assigned to the messages. The customer relays 132, 152 are positioned between the Internet 120 and the forwarding relays 134, 138, 154, 156 and function as an interface between the customer system 130, 150 (and, in some cases, a customer firewall) and the Internet 120 and control communication with the service provider system 110.

The system 100 of FIG. 1 is useful for illustrating that multiple forwarding relays 134, 138 may be connected to a single customer relay 132 and that a single forwarding relay 134 can support a large number of monitored relays 136 (i.e., a large monitored system to forwarding relay ratio). Additionally, forwarding relays 154, 156 may be linked to provide more complex configurations and to allow even more monitored systems to be supported within a customer system 130, 150. Customer management nodes 146, 164 used for displaying and, thus, monitoring collected and processed system data may be located anywhere within the system 100 such as within a customer system 150 as node 164 is or directly linked to the Internet 120 and located at a remote location as is node 146. In a typical system 100, more customer systems 130, 150 would be supported by a single service provider system 110 and within each customer system 130, 150 many more monitored relays or systems and forwarding relays would be provided, with FIG. 1 being simplified for clarity and brevity of description.

FIG. 2 shows a remote monitoring service system 200 that includes a single customer system 210 linked to a service provider system 284 via the Internet 282. FIG. 2 is useful for showing more of the components within the monitored system or relay 260, the forwarding relay 220, and the service provider system 284 that function separately and in combination to provide the high monitoring system to relay ratios and, importantly, to implement the unique store and forward messaging and other features of the communication protocol. While the components of forwarding relay 220 are provided in detail, many or all of these components would typically be provided within the customer relay 218 and the monitored system 260 as necessary to implement the relay-to-relay interfaces and communication protocol functions of the invention (with these relays being simplified for ease of illustration and description). As shown, the customer system 210 includes a firewall 214 connected to the Internet 282 and a customer relay 218 providing an interface to the firewall 214 and controlling communications with the service provider system 284.

According to an important aspect of the invention, the customer system 210 includes a forwarding relay 220 linked to the customer relay 218 and a monitored relay or system 260. The forwarding relay 220 controls messaging including accepting data from upstream sources and reliably and securely delivering it downstream according to the communication protocol of the invention. Throughout the following discussion, the monitored system 260 will be considered the most upstream point and the service provider system 284 the most downstream point with data (i.e., “messages”) flowing downstream from the monitored system 260 to the service provider system 284. The forwarding relay 220 accepts data from upstream and downstream sources and reliably and securely delivers it downstream and upstream, respectively. The relay 220 caches file images and supports a recipient list model for upstream (fan-out) propagation of such files. The relay 220 manages the registration of new monitored systems and manages retransmission of data to those new systems. Importantly, the forwarding relay 220 implements a priority scheme according to the protocol to facilitate efficient flow of data within the system 200. Preferably, each relay 220, 260, 218 within a service system has a similar internal structure or includes mechanisms for implementing the communication protocol.

The forwarding relay 220 includes two relay-to-relay interfaces 222, 250 for receiving and transmitting messages to connected relays 218, 260 including messages complying to the protocol. A store and forward mechanism 230 is included for processing messages received from upstream and downstream relays and for building and transmitting messages in a format complying with the protocol (such as the message 500 shown in FIG. 5). This includes a store and forward function that is preferably provided within each relay of the system 200 (and system 100 of FIG. 1) and in some embodiments, such message building and transmittal is priority-based with interruptions as defined by the protocol. To provide this functionality, the store and forward mechanism 230 includes a priority queue manager 232, a command processor 234, and a reliable message store mechanism 236 and is linked to memory 240 including a message store 242.

Briefly, the priority queue manager 232 is responsible for maintaining a date-of-arrival ordered list of commands and messages from upstream and downstream relays. The command processor 234 coordinates overall operations of the forwarding relay 220 by interpreting all command (internal) priority messages and also acts as the file cache manager, delayed transmission queue manager, and relay registry agent (as will become more clear from the description of FIGS. 3 and 4). The reliable message store mechanism 236 acts to process received messages and works in conjunction with the priority queue manager 232 to build messages according to the communication protocol from data in the message store 242 based on the priority queue library (e.g., queue manager 232) and to control transmission of these built messages. The mechanism 236 functions to guarantee the safety of messages as they are transmitted within the system 200 by creating images of the messages on disk 240 and implementing a commit/destroy function to manage the on-disk images. In general, a “message” represents a single unit of work that is passed between co-operating processes within the system 200 (such as the message 500 of FIG. 5). The priority queue manager 232 functions to generate priority queues. This allows the relay 220 to obtain a date-ordered set of priority queues directly from the mechanism 230.

Generally, the message store 242 stores all messages or data received from upstream and downstream sources while it is being processed for transmittal as a new message. The store 242 may take a number of forms. In one embodiment, the store 242 utilizes a UNIX file system to store message images in a hierarchical structure (such as based on a monitored system or message source identifier and a message priority). The queue library implements a doubly-linked list of elements and allows insertion to both the head and tail of the list with searching being done sequentially from the head of the queue to the tail (further explanation of the “store” function of the forwarding relay 220 is provided with reference to FIGS. 3 and 4). Messages are typically not stored in the queue but instead message descriptors are used to indicate the presence of messages in the message store 242. The queue manager 232 may create a number of queues in memory as part of the priority queue manager such as a queue for each priority level and extra queues for held messages which are stored awaiting proper registration of receiving relays and the like. A garbage collector 248 is provided to maintain the condition of the reliable message store 242 which involves removing messages or moving messages into an archival area (not shown) with the archiver 246 based on expiry policy of the relay 220 or system 200.

In some embodiments, the forwarding relay 220 with the store and forward mechanism 230 functions to send information based upon the priority assigned (e.g., by the transmitting device such as the monitored system 260 or service provider system 284) to the message. Priorities can be assigned or adjusted based on the system of origination, the function or classification of the message, and other criteria. For example, system internal messages may be assigned the highest priority and sent immediately (e.g., never delayed or within a set time period, such as 5 minutes of posting). Alerts may be set to have the next highest priority relative to the internal messages and sent immediately or within a set time period (barring network and Internet latencies) such as 5 minutes. Nominal trend data is typically smaller in volume and given the next highest priority level. High-volume collected data such as configuration data is given lowest priority. Hence, these four categories of messages may be assigned priorities of 0 to 3 with 0 being the highest priority. Of course, the particular priorities assigned for messages within the system 200 may be varied to practice the prioritization features of the present invention.

The monitored system 260 typically includes components to be monitored such as one or more CPUs 270, memory 272 having file systems 274 (such as storage area networks (SANs), file server systems, and the like) and disk systems 276, and a network interface 278 linked to a customer or public network 280 (such as a WAN, LAN, or other communication network). A user interface 265 is included to allow monitoring of the monitored system 260 (e.g., viewing of data collected at the monitored system 260, processed by the service provider system 284, and transmitted back via the forwarding relay 220 to the monitored system 260). The user interface 265 typically includes a display 266 (such as a monitor) and one or more web browsers 267 to allow viewing of screens of collected and processed data including events, alarms, status, trends, and other information useful for monitoring and evaluating operation of the monitored system 260. The web browsers 267 provide the access point for users of the user interface 265.

Data providers 268 are included to collect operating and other data from the monitored portions of the system 260 and a data provider manager 264 is provided to control the data providers 268 and to transmit messages to the forwarding relay 220 including assigning a priority to each message. Preferably, the data providers 268 and data provider manager 264 and the relays 220, 218 consume minimal resources on the customer system 210. In one embodiment, the CPU utilization on the monitored system 260 is less than about 1 percent of the total CPU utilization and the CPU utilization on the relay system is less than about 5 percent of the total CPU utilization. The data providers 268 typically collect data for a number of monitoring variables such as run queue and utilization for the CPU 270, utilization of memory 272 including information for the file systems 274 and disks 276, and collision, network errors, and deferred packets for the network interface 278. In addition to collecting monitoring variable data, the data providers 268 typically collect configuration data. The data providers 268 operate on a scheduled basis such as collecting trend data (e.g., monitoring variable information) every 10 minutes and only collecting configuration data once a week or some relatively longer period of time. The data provider manager 264 functions to coordinate collection of data by the data providers 268 and to broker the transmission of data with the relay 220 via relay to relay interface 262, which implements the communication protocol of the invention (and may include at least some of the components illustrated in the forwarding relay 220 to support the protocol).

The service provider system 284 is linked to the Internet 282 via the firewall 286 for communicating messages with the customer relay 218 and the forwarding relay 220. The service provider system 284 includes receivers 288 which are responsible for accepting data transmissions from the customer system 210 and brokering the data to the appropriate data loaders 294. Received messages or jobs are queued in job queue 292 and the job queue 292 holds the complete record of the data gathered by a provider 268 until it is processed by the data loaders 294. The job scheduler 290 is responsible for determining which jobs are run and in which order and enables loaders 294 to properly process incoming data. The data loaders 294 accept data from the receivers 288 via the job table in the database. The loaders 294 store the final form of the data in the database (not memory). The data loaders 294 are generally synchronized with the data providers 268 with, in some embodiments, a particular data loader 294 being matched to operate to load data from a particular data provider 268. The reporting web server 299 then functions to accumulate all the gathered and processed data and transmit or report it to the user interface 265. The types of reports may vary but typically include time-based monitoring data for trend analysis, system configuration data for system discovery and planning, and time-based monitoring data evaluated against a set of performance level metrics (e.g., alerts) and may be in HTML or other format.

Referring now to FIG. 3, a block diagram of the internal structure 300 of a forwarding relay, such as relay 220 of FIG. 2, is illustrated to more fully describe how the relays of the invention implement the pipeline or relay-to-relay communication protocol of the invention and support the fan-out and priority-based messaging functions of the invention. Each relay is connected to other relays by associating a downstream interface of one relay with the upstream relay of another (i.e., relay-to-relay interfaces), with the upstream terminus of the pipeline being the data provider manager or agent and the downstream terminus of the pipeline being the receiving agents or receivers. Relays pass messages to each other, and the messages may be of a particular format such as that shown in FIG. 5 according to the novel protocol.

As shown, the internal relay structure 300 includes an upstream interface 334 that coordinates all data transmissions to and from the relay 300 in the upstream direction (i.e., toward the monitored system). A message arriving 336 at the upstream interface 334 may be an internal command message or a data message (or message segment) with some internal commands destined for the command processor 304, e.g., “relay ID” and some internal commands being relevant for the upstream interface 334, e.g., “start of message” (SOM) and “end of message” (EOM) commands. To support file transmission, upon receipt of a SOM command the upstream interface 334 opens a file in its message assembly area 340. The SOM command has associated with it the priority of the message being transmitted. As data segments arrive from the same message, they are appended to the file in the file assembly area 340. When the EOM command is received, the upstream interface 334 closes the file and places it 356 on the appropriate work queue for the downstream work scanner 320 and increases the job counter 313 indicating the number of downstream jobs pending. The priority of the file being added to the downstream queues is compared against the highest priority register 315 and if the new file is of higher priority, that new priority is written to the highest priority register 315. The upstream interface 334 also receives registration command messages which are passed to the command processor 304 and upstream acknowledgement command messages which are passed to the command processor 304 for subsequent processing. The upstream interface 334 further controls the transmission throttle for upstream communications. In order not to consume all the available network bandwidth, transmitted data may be restricted to a predefined number of bytes per unit time, with the value of this restriction being a configurable and adjustable value.

The downstream work scanner 320 is provided to determine which messages are transmitted to the downstream interface 324. While the queues associated with the downstream work scanner 320 store files, the downstream work scanner 320 works with messages (with a file being composed of one or more messages or message segments) . The scanner 320 begins functioning by examining the job counter 313. When the job counter 313 is not zero there is work, and the scanner 320 reads the value of the highest priority register 315. The scanner 320 then obtains the next message and (e.g., a start of message, a data or message segment, or an end of message) from the highest priority work queue. The scanner 320 then sends the message to the downstream interface 324, such as by a block transmission (e.g., the scanner 320 waits for the message to be received prior to scanning for new work). The use of block transmissions is desirable for supporting throttling of the downstream interface 324. The scanner 320 also implements an acknowledgement handshake or ping pong flow control with the upstream interface of the downstream relay (not shown) according to the protocol (as explained in more detail with reference to FIG. 6 and as will become clear, an acknowledgment or response is not required for message segments or for shutdown command messages). When the downstream relay sends an acknowledgement command 374, the command is sent to the command processor 304 which routes it to the downstream work scanner 320. Upon receipt of the acknowledgement command, the scanner 320 releases the file from the work queues, decrements the job counter 313, and rescans the queues for the highest priority value.

The downstream interface 324 coordinates all transmissions to or from linked downstream relays (not shown). To allow the relay 300 to provide message transmission, the downstream interface 324, upon receipt of a message, transmits the message to the associated downstream relay. Throttling is provided by the downstream interface 324 by enforcing a limit on the amount of data that can be transmitted per unit of time. As with the upstream interface 334, the throttling value is a configurable and adjustable value or parameter. If the throttling value is exceeded, the downstream interface 324 does not read new data from the downstream work scanner 320. Once sufficient time has passed to allow new transmissions, the downstream interface 324 accepts the message from the work scanner 320 and proceeds to transmit it 372 downstream. During message reception, the interface 324 accepts messages 374 from the downstream relay (not shown) destined for the relay 300 or for upstream relays (not shown). The messages are routed in the same manner as the upstream interface 334 routes received messages but for two exceptions. First, upstream messages contain a recipient list of relay identifiers. These recipient lists have been implemented to reduce the duplication of data being transmitted to the intermediate or forwarding relays. Second, some upstream messages are actually command messages destined for upstream systems and have a priority of zero (highest priority) and a recipient list that includes upstream relay identifiers.

The upstream work scanner 330 is included to determine which messages are transmitted to the upstream interface 334 for transmittal to upstream relays (not shown). During message transmission, the scanner 330 examines the job counter 312 and when not zero, the scanner 330 reads the value of the highest priority register 314. The scanner 330 then obtains the next message (e.g., start of message, data or message segment, or end of message commands or messages) from the highest priority work queue 396. The scanner 330 then sends the retrieved message to the upstream interface 334, such as by blocked transmission (e.g., by waiting for receipt of message prior to scanning for new work) to support throttling at the upstream interface 334. The scanner 330 implements an acknowledgement handshake or ping pong protocol with the downstream interface of the immediate upstream relay 336 (not shown) and when an acknowledgement command is received from the upstream relay it is first sent to the command processor 304 and then routed to the scanner 330. Upon receipt of the acknowledgement, the scanner 330 releases the file from the work queues 396, decrements the job counter 312, and rescans the queues for the highest priority value. In some cases, it may not be possible to send a message to one or more of the upstream relays identified by the recipient list of the message. In this case, the scanner 330 passes the message to the command processor 304 for insertion in the delay queue 310. At some future time, the command processor 304 re-inserts a delayed transmission based on the registration of a recipient relay and the scanner 330 then accepts the message from the command processor 304 and re-queues it on the appropriate priority queue.

The command processor 304 acts as the overall coordinator of operations within the relay 300 and acts as the file cache manager, the delayed transmission queue manager, and the relay registry agent. The command processor 304 handles the processing of most command messages (with the exception of start of message (SOM) and end of message (EOM) command messages) within the relay 300. The most commonly processed command is the file acknowledgement command that indicates that the upstream or downstream recipient relay has received a complete message. When this command is received, the command processor 304 notifies the corresponding work scanner 320 or 330 to release the file from the work queues.

The command processor 304 acts as a file cache manager and in one embodiment, acts to only cache the current version of any software or configuration files in relays 300 with no children, as the file caches of parent relays hold all the files contained in child relays due to the hierarchical nature of the pipeline. Parents of such childless relays 300 will cache the current and previous versions of any software or configuration files. Since there exists within systems according to the invention the possibility that not all designated recipients of a message will be able to receive it, the command processor 304 is configured to manage delayed transmissions without adversely affecting other message traffic. If an upstream work scanner 330 is unable to deliver a message to a recipient, the file associated with that message is passed to the command processor 304 for inclusion on its delayed transmission queue 310. The command processor 304 further acts as a relay registry agent by making a record of the relay identifier of the registrant for storage in registry 308 when an upstream relay becomes active and sends a registration message to its downstream relay. The registration command message also includes a list of all configuration and software versions associated with the upstream relay. This list is compared by the command processor 304 to the list of required versions maintained in the file cache 348. Any upgrades in software or configuration files are sent by the command processor 304 to the upstream work scanner 330 for insertion onto the appropriate queues. The delayed transmission queue 310 is then scanned to determine if there are any messages on the queue that are destined for the new registrant. If so, these messages are passed to the upstream work scanner 330 for insertion onto the appropriate queues.

Referring now to FIG. 4 with further reference to FIG. 3, several of the processes or functions performed by an operating forwarding relay (such as relay 220 of FIG. 2 and 300 of FIG. 3) are more fully described to stress the important features of the invention. At 410 relay operations begin and the relay is initialized at 420. Initialization 420 of a relay starts with the command processor 304 and continues until the relay 300 is in a mode where it is ready to receive and transmit data with upstream relays and it is registered and ready to exchange data with downstream relays. After the command processor 304 is instantiated, the command processor 304 acts to clear 346 the relay identification registry 308. The command processor 304 then moves 352 all files that were placed upon the delayed transmission queue 310 to the upstream file queue area. The job counters 312, 313 are then reset to zero and the highest priority registers 314, 315 are set to zero.

Initialization 420 continues with starting the downstream work scanner 320 in its initialization state. In this state, the downstream work scanner 320 rebuilds the downstream job queues from images on the disk. Once the queues have been rebuilt, the downstream work scanner 320 sets the job counter 313 and the highest priority register 315 to the appropriate values. The scanner 320 then begins to process the transmission of the highest priority file on the queues. The downstream interface 324 then starts in its initialization state which causes it to issue a registration request 372 to the downstream relay. The upstream work scanner 330 is started in its initial state where it rebuilds its work queues, including those files that have been restored from the delayed transmission queue 310, and sets the job counter and the highest priority registers 312, 314 appropriately. The upstream work scanner 320 then processes the first file on the upstream work queues 396. Next, the upstream interface 334 is instantiated and conditions itself to accept connections and messages from upstream relays.

For proper pipeline communications, downstream relays need to know that an upstream relay has been initialized. In order to support this, the downstream relay processes at 430 registration requests from upstream relays. The upstream interface 334 receives a start of file command 336 and opens a file in the file assembly area 340. As additional data messages 336 are received, they are appended to the file in the file assembly area 340. When an end of file command 336 is received, the file in the file assembly area 340 is closed and the upstream interface 334 generates an acknowledgement message 342 to the upstream relay. The command file is passed 399 to the command processor 304. This file contains all the information required to register the upstream relay including a list of all configuration file versions, relay and agent versions, and provider versions.

The relay is registered 346 by the command processor 304 with the relay identification registry 308. The version information supplied by the upstream relay is compared at 348 to the configuration file information in the file cache and any deviations are noted. All deviations are corrected by transmitting 350 the new files from the cache to the upstream work scanner 330 for insertion 396 into the appropriate transmission queues. The command processor 304 then scans 352 the delayed work queue 310 to determine if any files contained on that queue 310 are destined for this newly registered relay. If delayed transmission files are found, they are passed 350 to the upstream work scanner 330 for insertion onto the appropriate work queues.

Downstream transmission at 440 encompasses the transmission of data or messages from an upstream (customer system) source to a downstream destination (service provider system) through a relay. The relay 300 supports a store-and-forward mechanism as well as a priority messaging system to provide enhanced safe delivery of data and with acceptable timing. Transmission 440 begins with the upstream interface 334 receiving 336 a start of message command. The upstream interface 334 creates a new file in the file assembly area 340 to store the incoming data in the data section of the message. The upstream interface 334 then receives a series of message segments or data sections within a message segment message 336. If the priority of the received message segment matches the priority of the file 340, the data segment of the data message is appended to this file 340. The upstream interface 334 then receives an end of message command 336 at which point the interface 334 closes the file 340 and issues an acknowledgement command message 342 to the upstream relay. The completed file is then added at 356 to the end of the appropriate downstream transmission work queue and the job queue counter 313 is incremented. The priority of this new file is compared 344 to the highest priority register 315 and if the new file has a higher priority, the highest priority register 315 is updated with the new, higher priority.

The downstream work scanner 320 then examines 360 the job counter register 313 to determine whether there is work pending. If work is determined to be pending, the scanner 320 obtains the value of the highest priority register 315. The file at the head of the highest priority queue is then accessed 366 and if there is no more work on this queue, the next queue is accessed and the highest priority register 315 is adjusted (decremented). If there is work on this queue but no open file, then a file is opened and the downstream work scanner or processor 320 issues a start of file command. If there is an open file, the next segment of the file is obtained by the scanner 320. If there is no more data in the file, the downstream work scanner 320 closes the file and issues an end of file command and a status of “waiting for acknowledgment” is set on the file. The message containing the command or data segment is transmitted 370 to the downstream interface 324 (e.g., as a blocked I/O operation). The downstream interface 324 accepts the message and transmits 372 it to the downstream relay in a format required by the protocol of the invention. Once the EOM message has been transmitted 372, the downstream relay responds with an acknowledgment command message 374 which is passed 378 to the command processor 304. The command processor 304 then routes 380 the acknowledgement to the downstream work scanner 320 which then removes 366 the file from the downstream queues. The scanner 320 also decrements 360 the job counter 313 to reflect completion of the transmission 440.

Upstream transmission 450 deals with the transfer of data from a downstream source to an upstream relay and is similar to downstream transmissions except that upstream messages include lists of recipient systems. Preferably, the relay 300 is configured to continue to make efforts to deliver the file to each of the systems on the list and to forward command files to upstream relays (even when not yet registered). The transmission 450 begins with the downstream interface 324 receiving 374 a SOM message. The downstream interface 324 responds by creating a new file in the file assembly area 384 to store the incoming file. The downstream interface 324 then receives a series of message segment messages 374 and if the priority of the received data messages match the priority of this file the data segment of the received message is appended to this file. The downstream interface 324 then receives an EOM command 374 and closes the file 384 and issues an acknowledgement command message 372 to the downstream relay.

The complete file is added at 386 to the end of the appropriate upstream transmission work queue and commands destined for upstream relays are also queued. The job queue counter 312 is incremented 388 and the priority of the new file is compared 390 to the highest priority register 314. If the new file has a higher priority than the highest priority register 314, the highest priority register 314 is updated with the new, higher priority. The upstream work scanner 330 examines 392 the job counter register 312 to determine whether there is work pending and if so, the scanner 330 obtains 394 the value of the highest priority register 314. The file at the head of the highest priority queue is accessed 396 and if there is no more work on this queue, the next queue is accessed and the highest priority register 314 is adjusted. If there is work on this queue but no open file, then the file is opened and the upstream work scanner 330 issues a start of file command. If there is an open file, the next segment of the file is obtained by the scanner 330. If there is no more data in the file, the scanner 330 closes the file and issues an EOM command message and a status of “waiting for acknowledgement” is set on the file.

The message containing a command in a header and a data field or section is transmitted 398 to the upstream interface 334 (e.g., a blocked I/O operation). The upstream interface 334 accepts the message and, as necessary, formats the message per the relay-to-relay protocol and transmits it 342 to the upstream relay. If the interface 334 is unable to contact the recipient, the upstream work scanner 330 is notified of the failure and the recipient is marked as “unavailable” on the recipient list. Once the EOM message has been transmitted 342, the upstream relay responds with an acknowledgement message 336 which is passed 399 to the command processor 304. The command processor 304 then routes 350 the acknowledgement to the upstream work scanner 330 which proceeds to repeat transmission steps until all recipients have been sent the file. If all recipients have received the file, the upstream scanner 330 removes the file at 396 from the upstream queues and decrements the job counter 312 to reflect the completion of the transmission. If any message of a file is not delivered by the upstream interface 334, a copy of the file is sent 350 to the command processor 304 which stores the file 352 in the delayed transmission queue 310.

The relays act to perform file cache management at 460 which allows for the remote management of each relay's file cache. The relay has a file cache to minimize the number of transmissions that must traverse the entire pipeline. The downstream interface 324 receives a message 374 from the downstream relay indicating the start of a cached file (such as with a SOM message). The interface accepts the transmission and rebuilds the file image in the file assembly area 384. Upon receipt of the EOM command 374, the downstream interface 324 sends an acknowledgment command 372 to the downstream relay. The interface 324 then passes the command 378 to the command processor 304 which interprets the command and takes the appropriate actions upon the cache file 348, such as adding the file to the cache, removing a file from the cache, returning a list of the file cache contents, and the like. Any responses generated by the command processor 304 are sent 380 to the downstream work scanner 320 for further processing.

The forwarding relays also process local commands at 470 which are command messages addressed to the local or receiving relay. The downstream interface 324 receives a SOM message 374 and opens a file in the file assembly area 384 to hold it. Subsequent data messages are appended to the open file until an EOM command message is received 374. Then, the downstream interface 324 generates an acknowledgement message for the command file 372. The command file is then passed 378 to the command processor 304 for processing. Any responses generated by the command processor 304 for transmittal to the downstream relay or message source are passed 380 to the downstream work scanner 320 for further processing. The relay operations 400 are then ended at 480. The order of the steps is not limiting and the steps do not have to be performed sequentially. In some embodiments, concurrent programming techniques are used such that at least steps 440, 450, 460, and 470 can all happen concurrently.

Due to the importance of the priority messaging function within the forwarding relays and receivers of the invention, the following further description of one embodiment of data transmission is provided. Files containing data to be sent upstream or downstream are added to the end of FIFO queues. The appropriate FIFO queue is selected based upon the priority assigned (by the sending device based on the corresponding process) to the file. In one embodiment, processes have a range of priorities spanning the priority value range (such as 1-9 with 1 being the highest priority and 9 the lowest or 0-3 with 0 being the highest priority). A special priority of zero is often reserved for use with control messages. The work scanners (or scanner processes) start looking at the FIFO queues beginning with the priority indicated in the highest priority register (or alternatively by starting each time with the highest priority FIFO queue, i.e., the zero priority queue). If a file is found, a segment or message of the file is sent to the appropriate relay interface. The work scanner then goes to the highest priority register (or directly to the appropriate queue) to determine which is presently the highest priority message to be sent. This priority messaging design allows higher priority work and messages to be processed as soon as it is received at the relay (e.g., within the next work cycle of the work scanner) and allows for the gradual transfer of lower priority, larger files that otherwise may block the pipeline (delay high priority messages).

The receiver is responsible for coordinating the reassembly of the segments or messages into a copy of the originally sent file. Similar to the forwarding relay, the receiver manages a set of priority elements but generally only has one file open for any particular priority. The receiver listens to transmissions from the pipeline and examines the priority of segments received. If there is no file associated with a segment's priority, the receiver creates a new file and adds the segment as the first element of the file. If a file already exists for the priority level, the receiver simply appends the segment to the end of the existing file. When an EOM message is received, the receiver closes the file for that priority and places the information in the job queue to indicate that the file is available for subsequent processing.

Referring now to FIG. 5, the pipeline protocol is based on a number of design elements or features that provide for time and space efficient and verifiable communication between relays. A message 500 formatted according to the protocol of the invention that is transmitted between relays is illustrated including a header 510 and a data section 520. The message 500 preferably is formatted so as to improve the ease of programming and to be verifiable. With these goals in mind, the header 510 has a fixed-length, L_{HEADER}, such as 16 bytes or some other useful fixed length. The 16-byte embodiment is useful for providing a space efficient header, i.e., about 1.1 percent of a standard TCP segment. The header 510 is preferably also a fixed-format header including a protocol field 512 (e.g., identifying the message as a protocol-formatted message such as five byte protocol ID of ‘{’ ‘0’ ‘0’ ‘0’ ‘1’), a command field 514, a length field 516, and NUL field 518.

The command field 514 identifies the type of message for processing and is preferably a command selected from a defined and limited set of commands. The command field 514 may also be a 4-byte field, such as 4 ASCII hexadecimal characters, containing a command. In one embodiment, the command set includes a relay identification command (RID), a relay identification acknowledgement command (RIDack), a start of message command (SOM), a start of message acknowledgment command (SOMack), a message segment command (MSGSEG), an end of message command (EOM), an end of message acknowledgment command (EOMack), and a shutdown or termination of connection command (SHUTDOWN). Each of these commands has an associated data content and format (i.e., data type) for data field 520. For example, the RID command data format is a relay ID, the RIDack command data format is a status along with the corresponding relay ID (and may be a negative acknowledgment), the SOM command data provides a message number or identifier along with priority and size, the SOMack command data type is status, the MSGSEG command is associated with a number of bytes with the length, LDATA, being within a preset range such as 0 to 1444 bytes such that the overall message length with a 16 byte header is 1460 or the length of a standard TCP segment, the EOM command has message number, priority, and SAVE data types, the EOMack command has a status data type, and the SHUTDOWN command typically has no associated data type.

In turn, each of the data types or formats is preferably well defined in a manner that facilitates proper processing within the relays. The following data type definitions are one exemplary combination of definitions that has proven useful in the protocol but is meant to be exemplary and not necessarily limiting with other definitions being apparent to those skilled in the arts. The relay ID data type includes a relay identifier (such as an ASCII string). The status data type includes a system error number value defined to provide positive or negative acknowledgment of receipt of a message (such as an ASCII decimal integer). The message number data type includes a message identifier or number (such as an ASCII decimal integer). The priority data type typically provides the message priority (such as an ASCII decimal integer in the priority range, e.g., 0 to 9 or 0 to 3). The size data type provides the message size in bytes (such as an ASCII decimal integer indicating 1 byte to 4 gigabytes). The save data type provides the save state for the sent message (such as an ASCII decimal integer, e.g., 0 indicating that the message should not be saved and 1 indicating the corresponding message should be saved).

With the format and content of a typical message 500 understood, transmission of messages under the communication protocol is more fully described with reference to FIG. 6 as communications would occur between two relays in a system, such as system 100 or 200. The transmission process 600 is useful for describing the protocol states involved in sending messages within a customer environment. A portion of the receiving protocol states or receiver actions are discussed with reference to FIG. 6 with additional states and defined responses provided in more detail after the discussion of the transmission process 600. The transmission process 600 starts at 604 (and prior to starting relays are registered as described above, communication links established, and software or mechanisms downloaded as shown for forwarding relay 220 of FIG. 2).

At 608, transmissions 600 continue with transmitting a relay ID message (RID) to the receiver including an identifier for the sender or transmitting relay. The receiver determines if the sender is registered to use the channel and if appropriate transmits a RIDack message to the sending relay. At 612, the sending relay waits for a preset period for the RIDack message in response to the sent RID message and if it is not received the connection is terminated at 658 without a message being transmitted (e.g., the termination or end of the transmission 600 is an orderly connection termination such as would occur on loss-of-connection). If a RIDack is received at 612, the message transmission phase is begun at 616 with the sending relay transmitting a start of message (SOM) message to the receiver. Again, flow control is provided by the sending relay expecting and waiting for an acknowledgment of the SOM message. If the SOMack is not received at 620 or is received and indicates a negative acknowledgment, then the connection is terminated at 658 without a message being sent. If, at 620, a SOMack message is received from the receiver, the sending relay starts sending the message content at 624 by sending a message segment (MSGSEG) message.

At 628, the sending relay checks to see if a higher priority message has been queued at the relay and if one has, the process 600 continues at 616 with a transmittal of a SOM message for the higher priority message (which is followed by other message transmission phase processes 620, 624, and 628 or if appropriate, 656). In this manner, a higher priority message can interrupt the transmission of a lower priority message. If at 628 there is not a higher priority message queued, the process 600 continues with the sending relay checking for additional message segments at 632. If additional message segments are present, the transmittal step 624 and higher priority message step 628 are repeated until the entire message is transmitted. If, however, there are no additional message segments at 632 the sending relay acts to send an end of message (EOM) message.

If an EOM acknowledgment (EOMack) is received from the receiver at 640, the sending relay then looks for unsent lower priority messages at 644 that may have been earlier interrupted by the present message. If such a lower priority message exists, the next segment is sent at 624, i.e., the lower priority transmission is resumed without having to be restarted at the beginning. If an EOMack is not received at 640 or is received and indicates a negative acknowledgment, then the connection is terminated at 658 without the message being sent. After waiting a period of time, the sender will restart at 604. If no lower priority, interrupted messages are detected at 644, the sending relay checks for additional messages at 648. If additional messages are queued at the relay, the next message is retrieved at 652 and transmission is begun at 616 with transmittal of a new SOM message. If no additional messages are queued, then connection is terminated at 656 (e.g., by sending a SHUTDOWN command) after one or more messages have been sent. Additionally, message transmission can be terminated early according to the protocol by the sender transmitting an EOM message with the SAVE being zero. Further, it should be noted that typically the last MSGSEG and EOM messages travel in the same underlying protocol segment (such as a TCP segment).

The protocol states for a receiving relay are based on passive acceptance of commands in messages and then verification of state. This can be thought of as a number of acceptable combinations of a first command followed by a new or second command which results in the receiving relay acting to verify a state and then, if appropriate, transmitting a reply command in a message. If an undefined or unanticipated command combination is received, an error is detected and the connection is terminated by the receiving relay. The following is a listing according to the protocol of acceptable command combinations along with verification steps and appropriate replies.

After the communication process is started, a RID message is expected with the appropriate reply being to transmit an RIDack message after verifying the relay ID is registered with the receiving relay. The RID command can be followed by a SOM message or a SHUTDOWN message. If a SOM message is received, the relay acts to verify the transmitted priority and to send a SOMack message to the sender. A SHUTDOWN message results in orderly shutdown or connection termination without a reply. Continuing with the receiving states, the SOM message may be followed by either a MSGSEG message or an EOM message. The MSGSEG message results in reception and processing of message segments without a reply being transmitted, which, significantly, provides for time efficient message transmission as individual segments are not acknowledged. If an EOM message is received at this point, the message file is now empty and the receiving relay acts to transmit an EOMack message to the sender.

After the MSGSEG message, the receiving relay expects to receive another MSGSEG message which results in message reception with no reply. The MSGSEG message may also be followed by a SOM message indicating a higher priority message is interrupting the prior message. The receiving relay then verifies the received priority and verifies the message stack depth and replies with a SOMack message to the sender. The protocol also allows the MSGSEG message to be followed by an EOM message indicating the end of the current message. The receiving relay responds by verifying the message number and priority provided in the EOM message and verifying the message stack depth, performs SAVE processing and transmits an EOMack message to the sender. After an EOM message is received, the protocol calls for either a SHUTDOWN or a SOM message to be received by the relay. The SHUTDOWN message results in orderly shutdown or termination of the connection while the SOM message results in verification of the priority provided in the SOM message and transmittal of a SOMack message to the sender.

From these defined transmitting and receiving state protocols, it can be seen that message transmittal generally requires a SOM message and an EOM message from sender to receiver, a SOMack message and an EOMack message from the receiver to the sender, and a number of MSGSEG messages from the sender to the receiver. The total number of messages per file or total message transfer between a sending and receiving relay is 4 messages or commands plus the number of message segments, which is significantly lower than the number that would be required if every message segment was acknowledged (i.e., 4 plus twice the number of message segments). In some cases, the total number of messages may be larger such as when a receiver encounters an error in saving the message during transmission, which may result in a number of message segments being transmitted prior to the receiving relay being able to provide a negative EOMack indicating the failure or error. Also, a message may in some cases be transferred twice, such as when the SOM, SOMack, MSGSEG, and EOM messages are all successfully transmitted but the EOMack is lost. Overall, the protocol results in time and space efficient transfer of messages between relays with priority-based interruption.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention, as hereinafter claimed.

We claim:

1. A communication protocol method implemented in a sending relay for controlling relay-to-relay communications, comprising:
transmitting a start of message command in a message to a receiving relay;
receiving a receipt acknowledgment for the start of message command from the receiving relay;
in response to the receipt acknowledgment, transmitting a message segment command and a message segment of a message file in a message to the receiving relay;
determining whether a next message segment remains in the message file;
after the determining, transmitting an end of message command in a message to the receiving relay when no next message segment remains in the message file;
after the end of message command transmitting, receiving a receipt acknowledgment for the end of message command from the receiving relay;
after the determining, when the next message segment remains, transmitting a message segment command and the next message segment of the message file in a message to the receiving relay; and
after the transmitting the next message segment, repeating the next message segment determining.

2. The method of claim 1, wherein the messages include a header having a header length and a data section having a data length, the header length being a fixed and equivalent length for each of the messages and the data length being selected from a length range and assigned separately for each of the messages.

3. The method of claim 2, wherein the header includes a protocol identification field, a command identification field including a command, and a length field including the data length for the message selected from the length range.

4. The method of claim 3, wherein the data section for each of the messages has a data content and a data format corresponding to the command in the header.

5. The method of claim 1, further including prior to the start of message transmitting, transmitting a relay identification command in a message to the receiving relay and receiving a receipt acknowledgment for the relay identification command from the receiving relay.

6. The method of claim 1, further including after the message segment transmitting, determining whether a next message file is queued for transmittal with a higher priority than a priority of the message file and when the next message file has a higher priority, transmitting a start of message command for the next message file in a message to the receiving relay and repeating the protocol method beginning with the receiving the receipt acknowledgment for the start of message command.

7. The messaging method of claim 6, further including after the receiving of the end of message acknowledgment for the next message file, resuming the protocol method for the interrupted message file with the determining whether a next message segment remains in the interrupted message file.

8. A communication protocol method implemented in a receiving relay for controlling relay-to-relay communications, comprising:
receiving a message from a sending relay including a relay identifier;
verifying based on the relay identifier the sending relay is registered with the receiving relay;
based on the verifying, transmitting a message to the sending relay including an acknowledgment of the relay identifier message;
after transmitting the relay identifier acknowledgment message, receiving a message from the sending relay including a start of message command and an identifier for a message file;
transmitting a message to the sending relay including an acknowledgment of the start of message command message;
after transmitting the start of message acknowledgment message, first receiving a message from the sending relay including a first message segment from the message file;
after the first receiving, second receiving a message from the sending relay including a second message segment from the message file;
receiving a message from the sending relay including an end of message command and an identifier for the message file; and
transmitting a message to the sending relay including an acknowledgment of the end of message command message.

9. The method of claim 8, wherein each of the messages includes a header and a data section, the header having a predefined length and including a command field and a length field defining a length of the data section.

10. The method of claim 9, wherein a command in the command field is selected from a set of protocol commands, each of the protocol commands having a data type defining data included in the data section of the messages.

11. The method of claim 8, further including before the second receiving of the second message segment from the message file, receiving a message from the sending relay including a start of message command and an identifier for a second message file, transmitting a message to the sending relay including an acknowledgment of the start of message command message for the second message file, and receiving messages including message segments for the second message file.

12. The method of claim 11, wherein the start of message command messages include priorities for the message file and the second message file with the second message file priority being higher than the message file priority.

13. The method of claim 11, further including receiving before the second receiving a message from the sending relay including an end of message command and an identifier for the second message file and in response transmitting a message to the sending relay including an acknowledgment of the end of message command message for the second message file.

14. A computer system for controlling communications on a digital data communication network, comprising:
a sending relay linked to the network including an interface including computer readable program code devices for:
transmitting a message including a message segment command and a message segment of a message file;
determining whether a next message segment remains in the message file;
after the determining, transmitting an end of message command in a message when no next message segment remains in the message file;
after the end of message command transmitting, receiving a receipt acknowledgment for the end of message command;
after the determining, when the next message segment remains, transmitting a message segment command and the next message segment of the message file in a message to the receiving relay; and
after the transmitting the next message segment, repeating the next message segment determining; and
a receiving relay linked to the network including an interface including computer readable program code devices for:
receiving the message segment messages from the sending relay;
receiving the message from the sending relay including the end of message command and an identifier for the message file; and
transmitting the receipt acknowledgment for the end of message command to the sending relay.

15. The system of claim 14, wherein the messages include a header having a header length and a data section having a data length, the header length being equal for each of the messages and the data length being within a data length range.

16. The system of claim 15, wherein the header includes a command field including a command identifier and a length field including a value defining the data length.

17. The system of claim 14, wherein the interface for the sending relay is further adapted for:
after the message segment transmitting, determining whether a next message file is queued in the sending relay for transmittal with a higher priority than a priority of the message file;
when the next message file has a higher priority, transmitting a start of message command for the next message file in a message to the receiving relay;
receiving a message from the receiving relay including an acknowledgment for the start of message command message; and
in response, transmitting a message including a message segment command and a message segment of the next message file.

18. The system of claim 17, wherein the interface for the receiving relay is further adapted for:
receiving the start of command message from the sending relay;
transmitting the acknowledgment message for the start of command message to the sending relay; and
receiving the message including the message segment for the next message file.

19. The system of claim 14, wherein the interfaces include logic for implementing the TCP/IP protocol suite in each of the message transmitting steps.

20. The system of claim 19, wherein the messages have a length equal to a length of a TCP segment.
